(19) United States
(12) Patent Application Publication
(10) Pub. No.: US 2008/0017001 A1
(43) Pub. Date: Jan. 24, 2008

(54) SAWING TABLE

(76) Inventor: Ching Wei Shen, Shue-Li Hsiang (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/458,735

(22) Filed: Jul. 20, 2006

(51) Int. Cl. B23D 45/06

(52) U.S. Cl. 83/438; 83/477.2

(57) ABSTRACT

A sawing table comprises a plate, a positioning device and a guiding device. The positioning device includes a positioning board and a fastening bar which is utilized to fasten the positioning board on the plate for providing a restriction. The guiding device is disposed under the plate and characterized by having lugs engaging the positioning board with chains. Thus, the positioning board is movably guided or alternatively fastened on the plate by operating the fastening bar.

### CROSS-REFERENCES TO RELATED APPLICATIONS

Not applicable.

### BACKGROUND OF THE INVENTION

1. Field of the Invention

The present invention relates to a sawing table; more particularly, to a sawing table providing an adjustable restriction for a work piece.

2. Descriptions of the Related Art

In the present days, buildings and mansions are widely constructed. After the main construction is accomplished, decoration issues for the construction would be subsequently concerned. During the decoration period, various manufacturing tools are needed, for example, hand tools, power drills, a sawing table, etc, while the sawing table with a rotary sawing machine is frequently utilized to saw or cut work pieces into segments during the decoration period. However, a bulky sawing table which may be made of cast iron or other weighty material is inconvenient for a user to move or carry. That is to say, the practical application of the bulky one would be limited. On the contrary, a sawing table, which is portable or facilitates to be assembled, would be suitable to be used among different working places by rapidly assembling and disassembling. Therefore, there has been recent interest in developing a sawing table which is light, portable, and detachable.

A conventional sawing table 1 is illustrated in FIG. 1. The sawing table 1 mainly comprises a main plate 11, a positioning board 13, guiding gears 153, two chains 155, and a rotary sawing machine (not shown). The main plate 11 has two opposite slots 111 for the chains 155 disposed therethrough. The main plate 11 further has a short slot 113, which is approximately disposed at the center of the main plate 11, for a circular saw 17 of the rotary sawing machine to partially protrude therethrough. A cylinder 151 is disposed between the guiding gears 153 to enable the guiding gears 153 to rotate synchronously. Moreover, side boards 191, 193, 195, and 197 are utilized to support the main plate 11 at an appropriate height. The sawing table 1 further comprises a driving board 14 which is utilized to guide the work pieces on the main plate 11 along the positioning board 13 and moving through the circular saw 17 for sawing. It is noted that the positioning board 13 is fixed onto the main plate 11 by operating a fastening bar 133. In view of convenience for assembling, the aforesaid elements are able to be assembled into the whole structure of the sawing table 1 rapidly and facilely. Similarly, the sawing table 1 can be disassembled for being carried or stored easily to facilitate users' daily use.

However, there still exist some disadvantages of the conventional sawing table 1. For instance, the slots 111, which provide a moving space for the chains 155, do not benefit for users as operating the sawing table 1. When the work pieces are rough and uneven in surface, it may have risks of getting stuck in the slots 111. It may cause dangers when the rotary sawing machine is operating.

Furthermore, in order to provide a sufficient moving space for the chains 155, the main plate 11 must have a certain thickness to be rigid enough. To give an example in practical use, the thickness of the chains 155 is approximate 9 mm. In view of the above, the main plate 11 should have a thickness greater than the thickness of the chains 155, such as at least 10 mm. In convention, for providing the main plate 11 with a certain thickness, at least two plates are usually adopted to stick or glue together for forming the main plate 11. Accordingly, the stacked plates may suffer from deformation or incomplete attachment.

Needless to say, small pieces and dusts would be produced when the sawing table 1 is utilized to saw the work pieces. The small pieces and dusts may fall into slots 111 and stick to the chains 155. Obviously, it would be harmful to the sawing table 1 for long-term operation.

Therefore, a novel sawing table, which facilitates to be assembled and detachable, for providing an adjustable restriction for a work piece needs to be developed in this field.

### SUMMARY OF THE INVENTION

The primary objective of this invention is to provide a sawing table. The sawing table comprises a plate and a positioning device which is provided for guiding the movement of working pieces. The positioning device is guided by a guiding device and fastened by a fastening bar, for adjusting the position corresponding to the dimension of the working pieces.

Another objective of this invention is to provide a sawing table. The guiding device of the sawing table is disposed under the plate. Thus, the plate can provide an overall working surface for the working pieces without slots.

Yet a further objective of this invention is to provide a sawing table. The plate of the sawing table can be composed of single layer which is selected from a group consisting essentially of lumber, aluminum, and plastic material. Therefore, it would reduce risks of deformation or incomplete attachment.

To achieve the above-mentioned objectives, the sawing table of the present invention comprises a plate, a positioning device and a guiding device. The plate comprises a surface, a first side, and a second side opposing to the first side. The positioning device comprises a positioning board, which is disposed on the surface of the plate, and a fastening bar. The positioning board further comprises a first end extending from the first side and a second end extending from the second side. The fastening bar is disposed on the first end for operably restricting the positioning board onto the plate. The guiding device is disposed under the plate and comprises a first chain disposed along the first side, a first connecting element, a second chain disposed along the second side, and a second connecting element. The first connecting element is utilized to connect the first end with the first chain and the second connecting element is utilized to connect the second end with the second chain. Specifically, the first and second connecting elements are lugs. According to the above disclosures, the positioning board is guided or alternatively fastened on the plate by operating the fastening bar.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating a conventional sawing table;

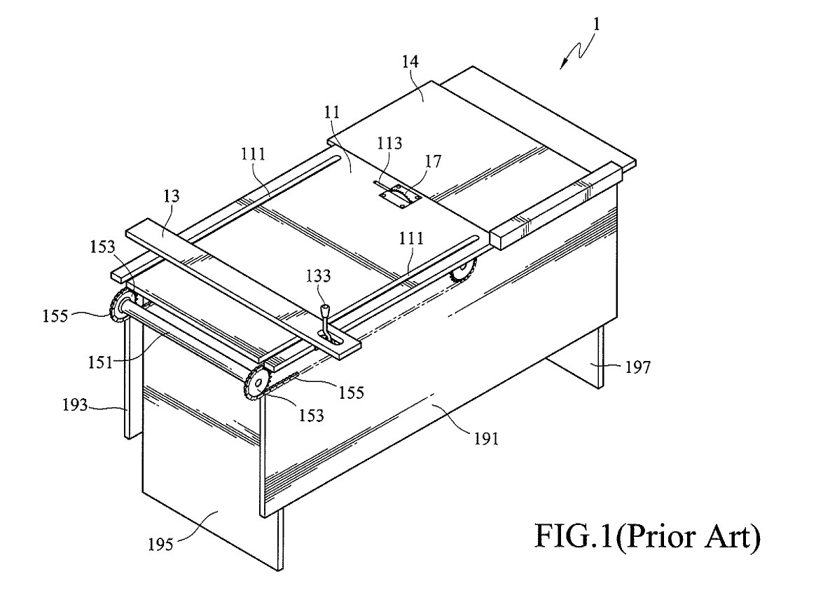

FIG. 2 is a schematic view illustrating a sawing table of the present invention; and

FIG. 3 is a cross-sectional view illustrating the sawing table of the present invention.

### DESCRIPTION OF THE PREFERRED EMBODIMENT

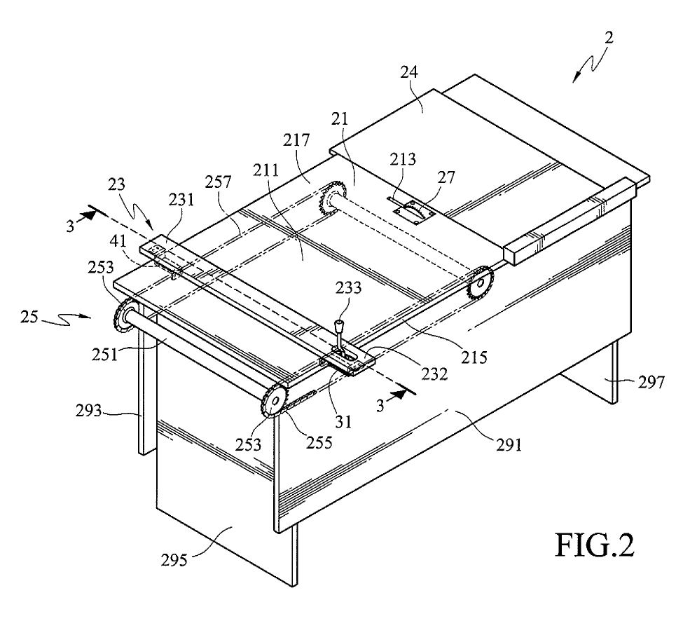

Please referring to FIG. 2, a sawing table 2 of the present invention is illustrated. The sawing table 2 comprises a plate 21, a positioning device 23, and a guiding device 25. The plate 21, which could be made of a material selected from a group consisting essentially of lumber, aluminum, and plastic material, comprises a surface 211, a first side 215, and a second side 217 which is opposing to the first side 215. The surface 211 of the plate 21 is utilized to provide a working plane for work pieces.

The sawing table 2 further comprises a plurality of side boards for supporting the plate at a height. In the present invention, preferably, four side boards 291, 293, 295, and 297 are disclosed. More specific, the side boards 291, 293, 295, and 297 can be easily assembled or rapidly disassembled to facilitate users to carry them individually.

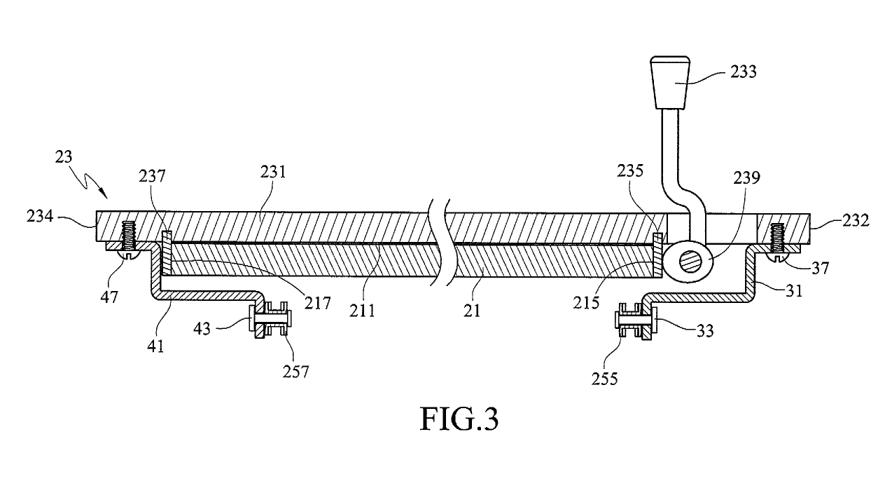

The positioning device 23 comprises a positioning board 231, which is disposed on the surface 211 of the plate 21, and a fastening bar 233. Similarly, the positioning board 231 is made of a material selected from a group consisting essentially of lumber, aluminum, and plastic material. Please simultaneously refer to FIG. 3, which is a cross-sectional view illustrating the sawing table 2 of the present invention. The positioning board 231 further comprises a first end 232 and a second end 234, wherein the first end 232 extends from the first side 215 and the second end 234 extends from the second side 217 above the surface 211 of the plate 21. Furthermore, the fastening bar 233 is disposed on the first end 232 for operably restricting the positioning board 231 on the plate 21.

The guiding device 25 of the present invention is disposed under the plate 21. The guiding device 25 comprises a first chain 255 disposed along the first side 215 and a second chain 257 disposed along the second side 217. The first and second chains 255, 257 are engaged with two gears 253 respectively that rotate synchronously with two cylinders. As shown in FIG. 2, a cylinder 251 is illustrated and the other (shown by broken lines) is disposed on the other side of the sawing table. The guiding device 25 further includes a first connecting element 31 and a second connecting element 41, wherein the first connecting element 31 is utilized to connect the first end 232 with the first chain 255 and the second connecting element 41 is utilized to connect the second end 234 with the second chain 257.

Preferably, the first connecting element 31 and the second connecting element 41 can be lugs. In addition, as shown in FIG. 3, the first connecting element 31 and second connecting element 41 are individually fastened onto the first end 232 and the second end 234 by screws 37, 47. Furthermore, the first and second connecting elements 31, 41 are individually connected to the first chain 255 and the second chain 257 by rivets 33, 43. By the first and second connecting elements 31, 41 fastening with the chains 255, 257, the positioning board 231 would be guided on the plate 21 and simultaneously moved with the chains 255, 257.

The operations of the fastening bar 233 would be described as follows. The fastening bar 233 comprises a first contacting element 235 that can be driven to contact onto the first side 215 when the fastening bar 233 is operated to an engaging position. Particularly, the fastening bar 233 comprises an eccentric cam 239. When the eccentric cam 239 is rotated by the fastening bar 233 to the engaging position, the first contacting element 235 would be driven to contact onto the first side 215.

When the fastening bar 233 is operated to an engaging position, the second contacting element 41 would contact to the second side 217. By the first and second contacting elements 235, 237 individually contacting to the first and second ends 215, 217, the positioning board 231 could be firmly fastened onto the plate 21.

Please refer to FIG. 2, the sawing table 2 further comprises a slot 213, which is disposed on the plate 21, and a rotary sawing machine (not shown). The rotary sawing machine is disposed under the sawing table 2 and has a circular saw 27 partially protruding through the slot 213. When a work piece is driven through the slot 213, it can be cut into segments by the circular saw 27.

By controlling the fastening bar 233, the positioning board 231 is movably guided or alternatively fastened on the plate 21. After the positioning board 231 being fastened, the work piece could be put onto the plate 21 and driven along the positioning board 231 by a driving board 24. Subsequently, the work piece would pass through the circular saw 27 and separated into segments.

The sawing table of the present invention comprises a plate without any slot for the chains 255, 257. Therefore, the rigidness thereof is strong enough that only one plate 21 is sufficient to serve as the working surface. Accordingly, the plate of the sawing table can be composed of single layer which is selected from a group consisting essentially of lumber, aluminum, and plastic material. Moreover, because the plate of the sawing table of the invention has a whole structure without slots therethrough at the sides, the small work pieces and dusts would not fall into the slots and get stuck to the chains.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A sawing table, comprising:
a plate wherein the plate comprises a surface, a first side, and a second side opposing to the first side;
a positioning device comprising a positioning board, disposed on the surface of the plate, and a fastening bar, wherein the positioning board further comprises a first end extending from the first side and a second end extending from the second side, the fastening bar disposed on the first end for operably restricting the positioning board on the plate; and
a guiding device, disposed under the plate, comprising a first chain disposed along the first side, a first connecting element, a second chain disposed along the second side, and a second connecting element, wherein the first connecting element is utilized to connect the first end with the first chain and the second connecting element is utilized to connect the second end with the second chain;
whereby the positioning board is alternatively guided or fastened on the plate by the fastening bar.

2. The sawing table as claimed in claim 1, wherein the fastening bar comprises a first contacting element contacting onto the first side when the fastening bar is operated to an engaging position.

3. The sawing table as claimed in claim 2, wherein the fastening bar comprises an eccentric cam for driving the first contacting element when the fastening bar is operated to the engaging position.

4. The sawing table as claimed in claim 2, wherein the positioning board includes a second contacting element disposed on the second end, the second contacting element contacting to the second side when the fastening bar is operated to the engaging position.

5. The sawing table as claimed in claim 1, further comprising a rotary sawing machine having a circular saw, and the plate having a slot allowing the circular saw to partially protrude therethrough.

6. The sawing table as claimed in claim 1, further comprising a driving board for guiding a work piece on the surface of the plate.

7. The sawing table as claimed in claim 1, further comprising a plurality of side boards for supporting the plate at a height.

8. The sawing table as claimed in claim 1, wherein the positioning board is made of a material selected from a group consisting essentially of lumber, aluminum, and plastic material.

9. The sawing table as claimed in claim 1, wherein the plate is made of a material selected from a group consisting essentially of lumber, aluminum, and plastic material.

10. The sawing table as claimed in claim 1, wherein the first and second connecting elements are individually fastened on the first end and the second end by screws.

11. The sawing table as claimed in claim 1, wherein the first and second connecting elements are individually connected to the first chain and the second chain by rivets for simultaneous movement.

12. A sawing table, comprising a plate and a positioning device, wherein the plate comprises a surface, a first side, and a second side opposing to the first side, the positioning device comprises a positioning board, disposed on the surface of the plate, and a fastening bar, the positioning board further comprises a first end extending from the first side and a second end extending from the second side, and the fastening bar is disposed on the first end for operably restricting the positioning board on the plate, characterized in that the sawing table further comprises:
a guiding device, disposed under the plate, comprising a first chain disposed along the first side, a first lug, a second chain disposed along the second side, and a second lug, wherein the first lug is utilized to connect the first end with the first chain and the second lug is utilized to connect the second end with the second chain,
whereby the positioning board is alternatively guided or fastened on the plate by the fastening bar.

13. The sawing table as claimed in claim 12, wherein the fastening bar comprises a first contacting element contacting onto the first side when the fastening bar is operated to an engaging position.

14. The sawing table as claimed in claim 13, wherein the fastening bar comprises an eccentric cam for driving the first contacting element when the fastening bar is operated to the engaging position.

15. The sawing table as claimed in claim 13, wherein the positioning board includes a second contacting element disposed on the second end, the second contacting element contacting to the second side when the fastening bar is operated to the engaging position.

16. The sawing table as claimed in claim 12, further comprising a rotary sawing machine having a circular saw, and the plate having a slot allowing the circular saw to partially protrude therethrough.

17. The sawing table as claimed in claim 12, further comprising a driving board for guiding a work piece on the surface of the plate.

18. The sawing table as claimed in claim 12, further comprising a plurality of side boards for supporting the plate at a height.

19. The sawing table as claimed in claim 12, wherein the positioning board is made of a material selected from a group consisting essentially of lumber, aluminum, and plastic material.

20. The sawing table as claimed in claim 12, wherein the plate is made of a material selected from a group consisting essentially of lumber, aluminum, and plastic material.

21. The sawing table as claimed in claim 12, wherein the first and second lugs are individually fastened on the first end and the second end by a screw.

22. The sawing table as claimed in claim 12, wherein the first and second lugs are individually connected to the first chain and the second chain by rivets for simultaneous movement.
